(19) United States
(12) Patent Application Publication
(10) Pub. No.: US 2008/0314143 A1
(43) Pub. Date: Dec. 25, 2008

(54) Device for measuring level of liquid

(76) Inventor: Kibong Choi, Seoul (KR)

Correspondence Address: BACON & THOMAS, PLLC, 625 SLATERS LANE, FOURTH FLOOR, ALEXANDRIA, VA, 22314-1176, US

(21) Appl. No.: 12/068,388

(22) Filed: Feb. 6, 2008

(30) Foreign Application Priority Data
Jun. 20, 2007 (KR) 10-2007-0060359

(51) Int. Cl. G01F 23/30

(52) U.S. Cl. 73/305

(57) ABSTRACT

A device for measuring the level of liquid is disclosed. The device according to the present invention comprises a housing opened up and down, and including a roller seating unit formed at a predetermined position on an inner circumference thereof and a housing hinge connection unit formed at one side on an outer circumference thereof; a roller including a roller shaft at each end to be rotatably received in the roller seating unit of the housing; a measuring tape winding around an outer circumference of the roller with both ends extended downward into a liquid storage tank; a buoyant member mounted to one end of the measuring tape to be raised and lowered in accordance with variation of the level of liquid in the liquid storage tank; a weight mounted to the other end of the measuring tape and tightly supporting the measuring tape by being raised and lowered contrary to the buoyant member; a housing cover covering a top of the housing, and including a cover hinge connection unit formed at one side for hinge-connection to the housing and a magnifier formed in the center thereof; and a connection cap connecting a lower end of the housing with an entry pipe of the liquid storage tank.

### BACKGROUND OF THE INVENTION

1. Field of the Invention

The present invention relates to a device for measuring the level of liquid, more particularly to a device for measuring liquid quantity in a tank which is buried in the ground.

2. Description of the Related Art

In general, a device for measuring the level of liquid (hereinafter, referred as a ‘liquid level measuring device’) is used to measure the liquid level such as oil stored in a large tank, for example, an oil storage tank of a service station.

Such a liquid level measuring device operates according to the following principle. A measuring tape is hung around an outer circumference of a roller spinning as axially supported in a housing, in such a manner that both ends of the measuring tape dangle down. A buoyant member is mounted to one end of the measuring tape whereas a weight which is lighter than the buoyant member is mounted to the other end of the measuring tape. As the buoyant member is raised or lowered in accordance with variation of the level of oil in the oil storage tank, the weight at the other end is lowered or raised contrary to the buoyant member. As a result, being pulled from each side by both the buoyant member and the weight, measuring tape is moved up and down along the outer circumference of the roller along with the buoyant member. Based on this principle, the level of liquid can be read through scales on the measuring tape.

There are several conventional liquid level measuring devices as described above.

As a first example, KR Utility Model Registration No. 20-0250422 discloses a liquid level measuring device having a similar structure as described above in terms of including a roller, measuring tape, a buoyant member and a weight. Besides, the disclosed measuring device has distinctiveness in that an outer circumference of a housing put on an entry pipe of an oil storage tank is flared upwards so that the housing has an inverse conical shape. In addition, the measuring device further includes a magnifier provided at an upper end of the housing, a housing cover screw-connected to the housing, and a guiding pipe formed at a lower end of the housing in fluid communication with the housing and extended to the oil storage tank disposed at a lower part.

The first conventional liquid level measuring device has high compatibility with the oil storage tank having diverse sizes of the entry pipe, by structuring the outer circumference of the housing in the conical shape as aforementioned. However, according to this structure, because the lower end of the housing is merely put on the entry pipe insertedly without a dedicated fixing member, the housing would easily slip off the entry pipe. Therefore, the measuring device would be tilted as a whole, consequently deteriorating accuracy of the liquid level measurement.

In addition, the screw-connection between the housing cover and the housing is inconvenient to release when the housing cover needs to be separated to check the roller or the measuring tape.

Being without a fall prevention member at a lower part of the roller mounted in the housing, the conventional measuring device cannot securely prevent fall of the roller into the oil storage tank.

In the conventional measuring device, a shaft of the roller is rotated as supported directly by the housing. Therefore, friction may be generated between the roller shaft and the housing, thereby continuously wearing the roller shaft and the housing.

Also, although the magnifier is provided for checking of the measuring tape, because there is not provided a dedicated indicator member, the scales of the measuring tape are read only by naked eyes. Therefore, the measurement may be performed incorrectly.

Furthermore, the guiding pipe has a small diameter to be disposed within an inner circumference of the entry pipe of the oil storage tank. For the measuring tape and the weight to be both arranged in the small-diameter guiding pipe and moved up and down according to vertical movement of the buoyant member, an inner space of the entry pipe is so narrow that the operation may not be favorably performed. Moreover, installation of the parts is complicated.

As a second example, US Patent Laid-open No. 2004-0144172 discloses a “liquid level gauge” which commonly includes the roller, the measuring tape, the buoyant member and the weight and further includes a connection cap dedicatedly connected to the entry pipe of the oil storage tank. Additionally, a housing of the liquid level gauge comprises a double cap-type body. A magnifier is provided at an upper end of the housing. The housing is screw-connected to a housing cover.

As in the first example, the screw-connection between the housing and the housing cover complicates separation of the housing cover when necessary for checking of the roller or the measuring tape. Due to absence of a fall prevention member at a lower part of the roller, the roller may fall down into the oil storage tank disposed at a lower part. A shaft of the roller directly supported by the housing may generate friction with the housing during rotation, thereby continuously wearing the roller shaft and the housing.

Furthermore, the structure of the housing is complicated since it has a double cap-type body. Although an arrow indicator is formed on one surface of the magnifier in the disclosed liquid level gauge, since position of the arrow indicator can be varied according to the result of the screw-connection, the arrow indicator does not help the measurement. Even if the arrow indicator is located at a right position, the arrow indicator pointing the scale of the measuring tape in only one direction may not be very helpful when measuring at the opposite side.

### SUMMARY OF THE INVENTION

Therefore, the present invention has been made in view of the above problems, and it is an object of the present invention to provide a device for measuring the level of liquid, capable of simplifyng the structure thereof by forming a housing as an integrated body, facilitating separation of a housing cover by connecting the housing with the housing cover by a hinge structure so that checking of a roller or a measuring tape can be conveniently performed, preventing fall of the roller by providing a fall prevention unit at a lower part of the roller mounted in the housing, preventing friction and consequent wear between a shaft of the roller and the housing, and improving accuracy of the measurement by enabling a user to check scales of the measuring tape from both sides.

In accordance with the present invention, the above and other objects can be accomplished by the provision of a device for measuring the level of liquid, comprising a housing opened up and down, and including a roller seating unit formed at a predetermined position on an inner circumference thereof and a housing hinge connection unit formed at one side on an outer circumference thereof, and a roller including a roller shaft at each end to be rotatably received in the roller seating unit of the housing, a measuring tape winding around an outer circumference of the roller and extended downward into a liquid storage tank with both ends thereof, a buoyant member mounted to one end of the measuring tape to be raised and lowered in accordance with variation of the level of liquid in the liquid storage tank, a weight mounted to the other end of the measuring tape and tightly supporting the measuring tape by being raised and lowered contrary to the buoyant member, a housing cover covering a top of the housing, and including a cover hinge connection unit formed at one side for hinge-connection to the housing and a magnifier formed in the center thereof, and a connection cap connecting a lower end of the housing with an entry pipe of the liquid storage tank.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view showing main parts around a housing of a liquid level measuring device according to an embodiment of the present invention;

FIG. 2 is an exploded perspective view showing the main parts around the housing of the liquid level measuring device according to an embodiment of the present invention;

FIG. 3 is a sectional view showing the main parts around the housing of the liquid level measuring device according to an embodiment of the present invention; and

FIG. 4 is a sectional view schematically showing the operation of the liquid level measuring device according to an embodiment of the present invention.

### DETAILED DESCRIPTION OF THE PREFERRED EMBODIMENTS

Hereinafter, an exemplary embodiment of the present invention will be described in detail with reference to the accompanying drawings.

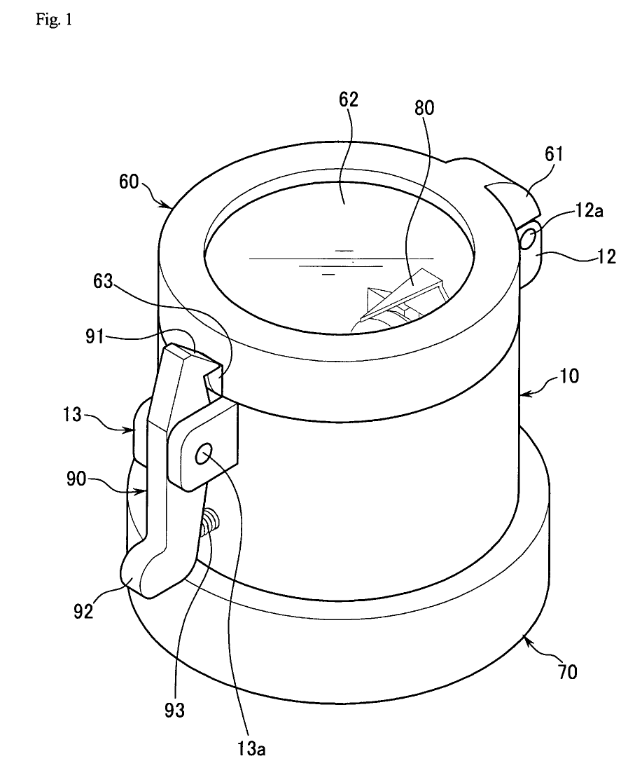

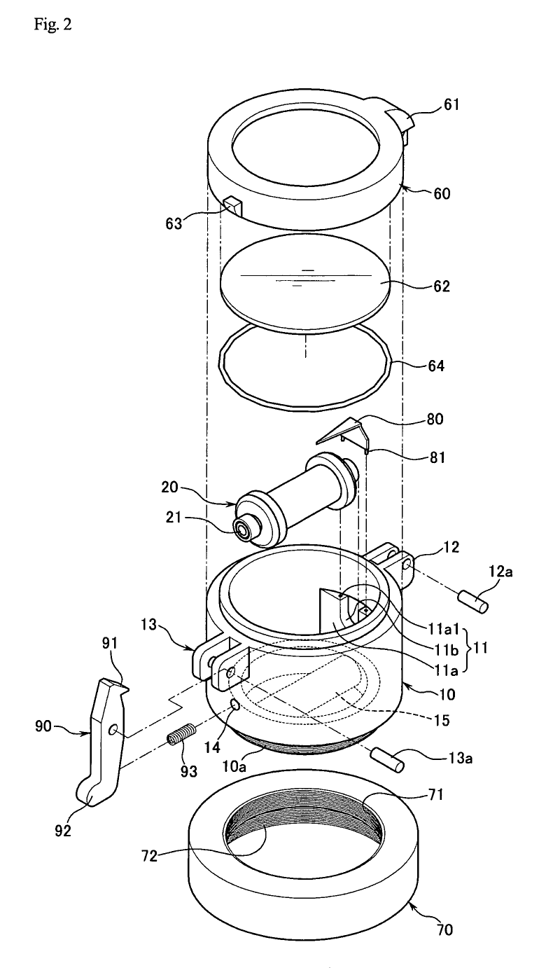

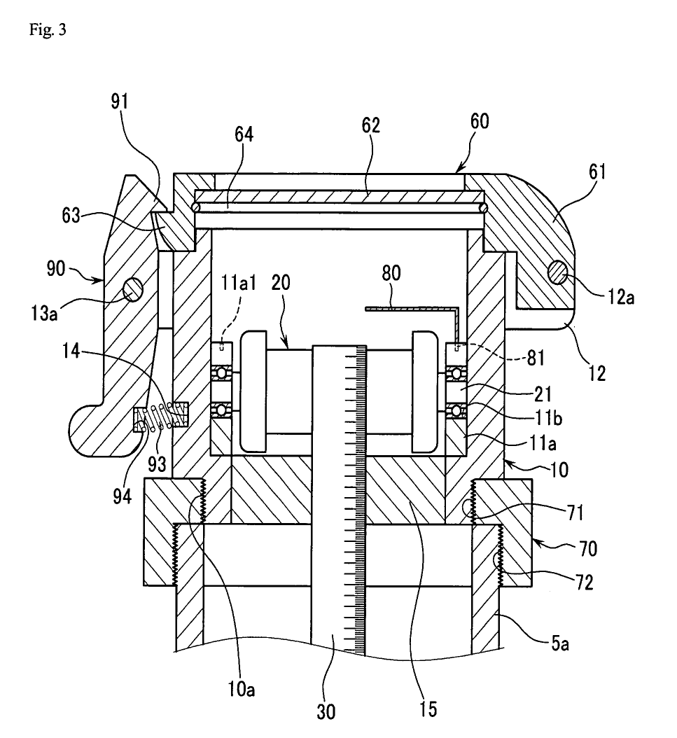

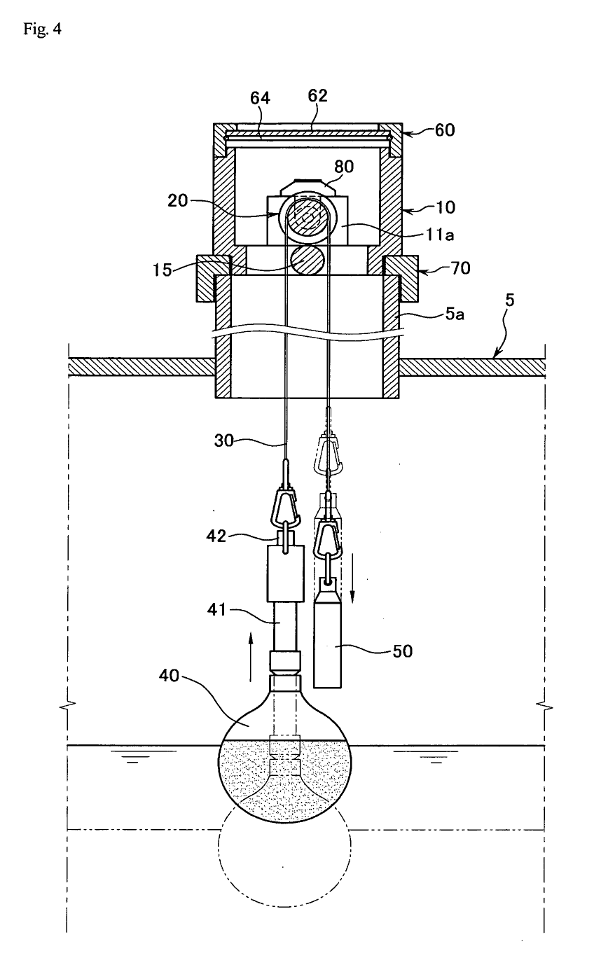

As shown in FIG. 1 through FIG. 4, a liquid level measuring device according to the embodiment of the present invention comprises a housing 10 including a roller seating unit 11 and a housing hinge connection unit 12, a roller 20 received in the roller seating unit 11, a measuring tape 30 winding around an outer circumference of the roller 20, a buoyant member 40 mounted to one end of the measuring tape 30, a weight 50 mounted to the other end of the measuring tape 30, a housing cover 60 covering a top of the housing 10, and a connection cap 70 connecting a lower end of the housing 10 with an entry pipe 5a of a liquid storage tank 5.

The housing 10 is vertically opened. A lower end of the housing 10 has a small-diameter pipe form and includes a screw thread 10a along an outer circumference thereof for screw-connection with the connection cap 70. Thus, as a whole, the housing 10 has a two-stepped pipe form. The roller seating unit 11 for receiving the roller 20 is disposed at a predetermined position on an inner circumference of the housing 10. The housing hinge connection unit 12 is disposed at one side on an outer circumference of the housing 10. The housing hinge connection unit 12 comprises a pair of protruding pieces spaced apart from each other to enclose both sides of a cover hinge connection unit 61 of the housing cover 60 and is hinge-connected to the cover hinge connection unit 61 by a hinge connection pin 12a penetrating the protruding pieces.

More specifically, the roller seating unit 11 of the housing 10 comprises a pair of bases 11a each having a flat front surface and protruded on opposite inner circumferential surfaces of the housing 10 by a length to partly receive and support a roller shaft 21. In addition, a seating recess 11b is formed at an upper middle part of the respective bases 11a, as opened upward and concaved at a lower side to seat the roller shaft 21 thereon.

An upper surface of the base 11a of the roller seating unit 11 is also flat and includes an indicator insertion recess 11a1 for inserting therein a pair of insertion protrusions 81 of an indicator 80.

The indicator insertion recess 11a1 is provided at both of the bases 11a so that the indicator 80 can be selectively mounted to either of the bases 11a.

On the opposite side of the housing hinge connection unit 12 of the housing 10, a locking hinge connection unit 13 is mounted, comprising a pair of protruding pieces spaced apart from each other by a predetermined distance to enclose both sides of a locking member 90, and hinge-connected to the locking member 90 by a hinge connection pin 13a penetrating the protruding pieces.

On the housing 10, additionally, a spring supporting recess 14 is formed at a lower part of the locking hinge connection unit 13 to receive and support one end of a spring 93.

A fall prevention member 15 is further formed on the inner circumference of the housing 10, being disposed under the roller 20 to prevent the roller 20 from falling downward.

Here, it is preferred that the fall prevention member 15 has a shaft form spanning a diameter of the housing 10 and attached to the inner circumference of the housing 10 by both ends thereof.

The roller 20 includes roller shafts 21 at both ends to be rotatably received in the roller seating unit 11 of the housing 10. Also, the roller 20 has a cylindrical shape so that the measuring tape 30 is wound around the middle of the roller 20.

The roller shaft 21 of the roller 20 is structured as a ball bearing that enables only the center of the roller 21 to be axially rotated, as received in the seating recess 11b.

The measuring tape 30 has a tape form winding around the outer circumference of the roller 20 with both ends thereof extended downward into the liquid storage tank 5.

The buoyant member 40 is mounted to one end of the measuring tape 30 to be raised and lowered depending on variation of the liquid level in the liquid storage tank 5. In addition, the buoyant member 40 has a balloon structure capable of adjusting the weight thereof by holding a weight material therein.

More specifically, the buoyant member 40 is deflated when being passed through the entry pipe 5a of the liquid storage tank 5. Upon being put into the liquid storage tank 5 through the entry pipe 5a, the buoyant member 40 is then inflated by an injection pipe 41 which is exposed out of the entry pipe 5a by an upper end and fluidly communicated with the buoyant member 40 by a lower end. Otherwise, the weight material may be put into the buoyant member 40, and the buoyant member 40 is covered with a cap 42 and submerged in the liquid.

The weight 50 is mounted to the other end of the measuring tape 30. The weight 50 weighs less than the buoyant member 40 to be raised and lowered contrary to the buoyant member 40 according to the up and down movement of the buoyant member 40, thereby tightly supporting the measuring tape 30.

The measuring tape 30, the buoyant member 40, and the weight 50 may be implemented by selectively applying various well-known arts.

The housing cover 60 covers the top of the housing 10 and is hinged upon the housing hinge connection unit 12 of the housing 10 through the cover hinge connection unit 61 formed at one side thereof. In addition, the housing cover 60 has a ring shape including a magnifier 62 in the center.

Furthermore, a locking protrusion 63 is formed on an outer circumference of the housing cover 60 at the opposite side to the cover hinge connection unit 61, to fix a locking hook 91 of the locking member 90.

A packing 64 is further provided to hermetically fix the magnifier 62 to the housing cover 60.

The connection cap 70 has a ring shape and includes screw threads 71 and 72 on upper and lower ends of an inner circumference thereof in order to connect the lower end of the housing 10 with the entry pipe 5a of the liquid storage tank 5.

Preferably, the connection cap 70 is structured to be variable in the diameter at the lower end, while having a fixed diameter at the upper end connected with the housing 10, in order to cope with various sizes of the entry pipe 5a of the liquid storage tank 5, thereby improving compatibility.

The indicator 80 is formed to help precisely read scales of the measuring tape 30. For this, an upper end of the indicator 80 is pointed and bent toward the scales. A lower end of the indicator 80 includes the insertion protrusions 81 to be inserted in the indicator insertion recesses 11a1 of the base 11a.

The locking member 90 is mounted on the opposite side to the housing hinge connection unit 12 of the housing 10 to support the housing cover 60 that covers the housing 10. The locking member 90 is hinged upon the locking hinge connection unit 13 of the housing 10 by the middle part thereof, and comprises the locking hook 91 formed at an upper end to lock the housing cover 60 and a handle 92 formed at a lower end to release the locking hook 91 by pivoting the locking hook 91 backward.

The spring 93 is disposed between the handle 92 of the locking member 90 and the outer circumference of the housing 10 to tightly support the locking of the locking hook 91.

In addition, a spring supporting recess 94 is further formed on an inner surface of the locking member 90, which contacts the spring 93, to receive and support the spring 93.

In the above-structured liquid level measuring device, the housing cover 60 mounted with the magnifier 62 is openably mounted to the housing 10 through the hinge connection. While the roller 21 is arranged in the roller seating unit 11 in the housing 10, the indicator 80 is mounted simultaneously. The measuring tape 30 is wound around the outer circumference of the roller 21. Next, both ends of the measuring tape 30 are mounted with the buoyant member 40 and the weight 50 respectively and then put into the liquid storage tank 5 through the entry pipe 5a.

Here, the buoyant member 40 is deflated before being put into the entry pipe 5a, inflated as desired after passing through the entry pipe 5a, and then submerged in the liquid.

Next, the housing cover 60 covers the top of the housing 10 and is securely locked by the locking member 90. The lower end of the housing 10 is connected with the entry pipe 5a through the connection cap 70. Thus, installation of the liquid level measuring device to the liquid storage tank 5 is completed.

When the liquid level increases in this state, the buoyant member 40 is accordingly raised. On the contrary, the weight 50 at the opposite side is lowered as much. Therefore, the measuring tape 30 interconnecting the buoyant member 40 and the weight 50 is moved along the roller 20. As a result, a user is able to read variation of the scales of the measuring tape 30 using the indicator 80 from the outside through the magnifier 62 mounted to the housing cover 60. Consequently, measurement of the level of liquid in the liquid storage tank 5 can be performed accurately.

For example, when the user has to change the measuring position to the opposite side during the measurement or when the measuring tape 30 deviates from its correct position during the operation, the roller 20, the measuring tape 30 or the indicator 80 may require checking. In this case, the housing cover 60 can be easily opened by releasing the locking member 90 using the handle 92. Therefore, the checking of the parts can be performed conveniently and promptly.

Although the roller 20 falls during the checking by the user's mistake, the roller 20 can be prevented from falling into the liquid storage tank 5 by the fall prevention member 15 provided at the lower end of the housing 10.

As can be appreciated from the above description, the liquid level measuring device according to the present invention is capable of simplifying the structure by having an integrated housing, conveniently separating a housing cover when checking of parts such as a roller and a measuring tape is necessary by connecting the housing cover to the housing through a hinge system, preventing the roller from falling into a liquid storage tank by comprising a fall prevention member under the roller in the housing, preventing frictional wear of a roller shaft and the housing, and improving accuracy of measurement by enabling scales of the measuring tape to be read from both sides.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A device for measuring the level of liquid, comprising:
a housing opened up and down, and including a roller seating unit formed at a predetermined position on an inner circumference thereof and a housing hinge connection unit formed at one side on an outer circumference thereof;
a roller including a roller shaft at each end to be rotatably received in the roller seating unit of the housing;
a measuring tape winding around an outer circumference of the roller with both ends extended downward into a liquid storage tank;
a buoyant member mounted to one end of the measuring tape to be raised and lowered in accordance with variation of the level of liquid in the liquid storage tank;
a weight mounted to the other end of the measuring tape and tightly supporting the measuring tape as being raised and lowered contrary to the buoyant member;
a housing cover covering a top of the housing, and including a cover hinge connection unit formed at one side for hinge-connection to the housing and a magnifier formed in the center thereof; and
a connection cap connecting a lower end of the housing with an entry pipe of the liquid storage tank.

2. The liquid level measuring device according to claim 1, wherein the roller seating unit of the housing comprises:
a pair of bases protruded on opposite inner circumferential surfaces of the housing toward the center by a length of the roller shaft; and
a seating recess formed at an upper middle part of the respective bases, as opened upward and concaved at a lower side to seat the roller shaft thereon.

3. The liquid level measuring device according to claim 2, wherein the base of the roller seating unit has a flat upper surface that includes an indicator insertion recess, and
an indicator is further comprised, having an upper end thereof pointed and bent toward the center to indicate scales of the measuring tape and including insertion protrusions formed at a lower end thereof to be mounted into the indicator insertion recess.

4. The liquid level measuring device according to claim 1, further comprising a locking member mounted to the housing at the opposite side to the housing hinge connection unit in order to lock the housing cover as covering the housing,
wherein the locking member is hinged by a middle part thereof to a locking hinge connection unit formed at the outer circumference of the housing, and comprises a locking hook formed at an upper end to lock the housing cover and a handle formed at a lower end to release the locking hook by pivoting the locking hook backward.

5. The liquid level measuring device according to claim 1, further comprising a fall prevention unit formed at the inner circumference of the housing to be disposed under the roller so as to prevent the roller from falling to a lower part.

6. The liquid level measuring device according to claim 5, wherein the fall prevention unit has a shaft form spanning a diameter of the housing and attached to the inner circumference of the housing by both ends thereof.
